(19) United States
(12) Patent Application Publication
(10) Pub. No.: US 2004/0119194 A1
(43) Pub. Date: Jun. 24, 2004

(54) Method for making electrodes for electrochemical cells

(76) Inventors: Boyko Aladjov, Rochester Hills, MI (US); Stanford R. Ovshinsky, Bloomfield Hills, MI (US); Srinivasan Venkatesan, Southfield, MI (US); Bora Tekkanat, Rochester Hills, CA (US); Subhash K. Dhar, Bloomfield, MI (US)

Correspondence Address: Philip H. Schlazer, Energy Conversion Devices, Inc., 2956 Waterview Drive, Rochester Hills, MI, 48309, US

(21) Appl. No.: 10/411,511

(22) Filed: Apr. 10, 2003

Related U.S. Application Data
(63) Continuation-in-part of application No. 10/329,221, filed on Dec. 24, 2002.

(51) Int. Cl. B29C 47/00

(52) U.S. Cl. 264/176.1

(57) ABSTRACT

A method for making an electrode for an electrochemical cell. The electrode is preferably made by mixing and heating an active electrode material with a polymeric binder in an extruder to form an active composition. The active composition is extruded out of the opening of the extruder as a sheet of material which may be affixed to a conductive support.

### RELATED APPLICATION INFORMATION

The present invention is a continuation-in-part of U.S. patent application Ser. No. 10/329,221 filed on Dec. 24, 2002. The disclosure of U.S. patent application Ser. No. 10/329,221 is hereby incorporated by reference herein.

### FIELD OF THE INVENTION

The present invention relates to electrodes for electrochemical cells. In particular, the present invention relates to methods for making electrodes for electrochemical cells.

### BACKGROUND OF THE INVENTION

In rechargeable electrochemical battery cells, weight and portability are important considerations. It is also advantageous for rechargeable battery cells to have long operating lives without the necessity of periodic maintenance. Rechargeable battery cells are used in numerous consumer devices such as calculators, portable radios, and cellular phones. They are often configured into a sealed power pack that is designed as an integral part of a specific device. Rechargeable battery cells can also be configured as larger “battery modules” or “battery packs”.

Rechargeable battery cells may be classified as “nonaqueous” cells or “aqueous” cells. An example of a nonaqueous electrochemical battery cell is a lithium-ion cell which uses intercalation compounds for both anode and cathode, and a liquid organic or polymer electrolyte. Aqueous electrochemical cells may be classified as either “acidic” or “alkaline”. An example of an acidic electrochemical battery cell is a lead-acid cell which uses lead dioxide as the active material of the positive electrode and metallic lead, in a high-surface area porous structure, as the negative active material. Examples of alkaline electrochemical battery cells are nickel cadmium cells (Ni-Cd) and nickel-metal hydride cells (Ni-MH). Ni-MH cells use negative electrodes having a hydrogen absorbing alloy as the active material. The hydrogen absorbing alloy is capable of the reversible electrochemical storage of hydrogen. Ni-MH cells typically use a positive electrode having nickel hydroxide as the active material. The negative and positive electrodes are spaced apart in an alkaline electrolyte such as potassium hydroxide.

Upon application of an electrical current across a Ni-MH battery cell, the hydrogen absorbing alloy active material of the negative electrode is charged by the absorption of hydrogen formed by electrochemical water discharge reaction and the electrochemical generation of a hydroxyl ion as shown in equation (1):

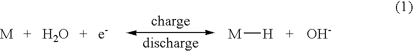

The negative electrode reactions are reversible. Upon discharge, the stored hydrogen is released from the metal hydride to form a water molecule and release an electron.

Certain hydrogen absorbing alloys, called “Ovonic” alloys, result from tailoring the local chemical order and local structural order by the incorporation of selected modifier elements into a host matrix. Disordered hydrogen absorbing alloys have a substantially increased density of catalytically active sites and storage sites compared to single or multi-phase crystalline materials. These additional sites are responsible for improved efficiency of electrochemical charging/discharging and an increase in electrical energy storage capacity. The nature and number of storage sites can even be designed independently of the catalytically active sites. More specifically, these alloys are tailored to allow bulk storage of the dissociated hydrogen atoms at bonding strengths within the range of reversibility suitable for use in secondary battery applications.

Some extremely efficient electrochemical hydrogen storage alloys were formulated, based on the disordered materials described above. These are the Ti—V-Zr-Ni type active materials such as disclosed in U.S. Pat. No. 4,551,400 (“the '400 patent”) the disclosure of which is incorporated herein by reference. These materials reversibly form hydrides in order to store hydrogen. All the materials used in the '400 patent utilize a generic Ti—V—Ni composition, where at least Ti, V, and Ni are present and may be modified with Cr, Zr, and Al. The materials of the '400 patent are multiphase materials, which may contain, but are not limited to, one or more phases with C₁₄ and C₁₅ type crystal structures.

Other Ti—V-Zr-Ni alloys, also used for rechargeable hydrogen storage negative electrodes, are described in U.S. Pat. No. 4,728,586 (“the '586 patent”), the contents of which is incorporated herein by reference. The '586 patent describes a specific sub-class of Ti—V-Ni-Zr alloys comprising Ti, V, Zr, Ni, and a fifth component, Cr. The '586 patent, mentions the possibility of additives and modifiers beyond the Ti, V, Zr, Ni, and Cr components of the alloys, and generally discusses specific additives and modifiers, the amounts and interactions of these modifiers, and the particular benefits that could be expected from them. Other hydrogen absorbing alloy materials are discussed in U.S. Pat. Nos. 5,096,667, 5,135,589, 5,277,999, 5,238,756, 5,407,761, and 5,536,591, the contents of which are incorporated herein by reference.

The reactions that take place at the nickel hydroxide positive electrode of a Ni-MH battery cell are shown in equation (2)

Ni(OH)₂+OH⁻ [symbol] NiOOH+H₂O+e⁻ (2)

After the first formation charge of the electrochemical cell, the nickel hydroxide is oxidized to form nickel oxyhydroxide. During discharge of the electrochemical cell, the nickel oxyhydroxide is reduced to form beta nickel hydroxide as shown by the following reaction:

NiOOH+H₂O+e⁻ [symbol] b-Ni(OH)₂+OH⁻ (3)

The charging efficiency of the positive electrode and the utilization of the positive electrode material is affected by the oxygen evolution process which is controlled by the reaction:

2OH⁻ [symbol] H₂O+½O₂+2e⁻ (4)

During the charging process, a portion of the current applied to the electrochemical cell for the purpose of charging, is instead consumed by a parallel oxygen evolution reaction (4). The oxygen evolution reaction generally begins when the electrochemical cell is approximately 20-30% charged and increases with the increased charge. The oxygen evolution reaction is also more prevalent with increased temperatures. The oxygen evolution reaction (4) is not desirable and contributes to lower utilization rates upon charging, can cause a pressure build-up within the electrochemical cell, and can upon further oxidation change the nickel oxyhydroxide into its less conductive forms. One reason both reactions occur is that their electrochemical potential values are very close. Anything that can be done to widen the gap between them (i.e., lowering the nickel reaction potential in reaction (2) or raising the reaction potential of the oxygen evolution reaction (4)) will contribute to higher utilization rates. It is noted that the reaction potential of the oxygen evolution reaction (4) is also referred to as the oxygen evolution potential.

Furthermore, the electrochemical reaction potential of reaction (4) is highly temperature dependent. At lower temperatures, oxygen evolution is low and the charging efficiency of the nickel positive electrode is high. However, at higher temperatures, the electrochemical reaction potential of reaction (4) decreases and the rate of the oxygen evolution reaction (4) increases so that the charging efficiency of the nickel hydroxide positive electrode drops.

Generally, any nickel hydroxide material may be used in a Ni-MH battery cell. The nickel hydroxide material used may be a disordered material. The use of disordered materials allow for permanent alteration of the properties of the material by engineering the local and intermediate range order. The general principals are discussed in more details in U.S. Pat. No. 5,348,822 and U.S. Pat. No. 6,086,843, the contents of which are incorporated by reference herein. The nickel hydroxide material may be compositionally disordered. “Compositionally disordered” as used herein is specifically defined to mean that this material contains at least one compositional modifier and/or a chemical modifier. Also, the nickel hydroxide material may also be structurally disordered. “Structurally disordered” as used herein is specifically defined to mean that the material has a conductive surface and filamentous regions of higher conductivity, and further, that the material has multiple or mixed phases where alpha, beta, and gamma-phase regions may exist individually or in combination.

The nickel hydroxide material may comprise a compositionally and structurally disordered multiphase nickel hydroxide host matrix which includes at least one modifier chosen from the group consisting of Al, Ba, Bi, Ca, Co, Cr, Cu, F, Fe, In, K, La, Li, Mg, Mn, Na, Nd, Pb, Pr, Ru, Sb, Sc, Se, Sn, Sr, Te, Ti, Y, and Zn. Preferably, the nickel hydroxide material comprises a compositionally and structurally disordered multiphase nickel hydroxide host matrix which includes at least three modifiers chosen from the group consisting of Al, Ba, Bi, Ca, Co, Cr, Cu, F, Fe, In, K, La, Li, Mg, Mn, Na, Nd, Pb, Pr, Ru, Sb, Sc, Se, Sn, Sr, Te, Ti, Y, and Zn. These embodiments are discussed in detail in commonly assigned U.S. Pat. No. 5,637,423 the contents of which is incorporated by reference herein.

The nickel hydroxide materials may be multiphase polycrystalline materials having at least one gamma-phase that contain compositional modifiers or combinations of compositional and chemical modifiers that promote the multiphase structure and the presence of gamma-phase materials. These compositional modifiers are chosen from the group consisting of Al, Bi, Co, Cr, Cu, Fe, In, LaH₃, Mg, Mn, Ru, Sb, Sn, TiH₂, TiO, Zn. Preferably, at least three compositional modifiers are used. The nickel hydroxide materials may include the non-substitutional incorporation of at least one chemical modifier around the plates of the material. The phrase “non-substitutional incorporation around the plates”, as used herein means the incorporation into interlamellar sites or at edges of plates. These chemical modifiers are preferably chosen from the group consisting of Al, Ba, Ca, Co, Cr, Cu, F, Fe, K, Li, Mg, Mn, Na, Sr, and Zn.

As a result of their disordered structure and improved conductivity, the nickel hydroxide materials do not have distinct oxidation states such as 2⁺, 3⁺, or 4⁺. Rather, these materials form graded systems that pass 1.0 to 1.7 and higher electrons.

The nickel hydroxide material may comprise a solid solution nickel hydroxide material having a multiphase structure that comprises at least one polycrystalline gamma-phase including a polycrystalline gamma-phase unit cell comprising spacedly disposed plates with at least one chemical modifier incorporated around said plates, said plates having a range of stable intersheet distances corresponding to a 2+oxidation state and a 3.5+, or greater, oxidation state; and at least three compositional modifiers incorporated into the solid solution nickel hydroxide material to promote the multiphase structure. This embodiment is fully described in commonly assigned U.S. Pat. No. 5,348,822, the contents of which is incorporated by reference herein.

Preferably, one of the chemical modifiers is chosen from the group consisting of Al, Ba, Ca, Co, Cr, Cu, F, Fe, K, Li, Mg, Mn, Na, Sr, and Zn. The compositional modifiers may be chosen from the group consisting of a metal, a metallic oxide, a metallic oxide alloy, a metal hydride, and a metal hydride alloy. Preferably, the compositional modifiers are chosen from the group consisting of Al, Bi, Co, Cr, Cu, Fe, In, LaH₃, Mn, Ru, Sb, Sn, TiH₂, TiO, and Zn. In one embodiment, one of the compositional modifiers is chosen from the group consisting of Al, Bi, Co, Cr, Cu, Fe, In, LaH₃, Mn, Ru, Sb, Sn, TiH₂, TiO, and Zn. In another embodiment, one of the compositional modifiers is Co. In an alternate embodiment, two of the compositional modifiers are Co and Zn. The nickel hydroxide material may contain 5 to 30 atomic percent, and preferable 10 to 20 atomic percent, of the compositional or chemical modifiers described above.

The disordered nickel hydroxide electrode materials may include at least one structure selected from the group consisting of (i) amorphous; (ii) microcrystalline; (iii) polycrystalline lacking long range compositional order; and (iv) any combination of these amorphous, microcrystalline, or polycrystalline structures. A general concept of the present invention is that a disordered active material can more effectively accomplish the objectives of multi-electron transfer, stability on cycling, low swelling, and wide operating temperature than prior art modifications.

Also, the nickel hydroxide material may be a structurally disordered material comprising multiple or mixed phases where alpha, beta, and gamma-phase region may exist individually or in combination and where the nickel hydroxide has a conductive surface and filamentous regions of higher conductivity.

Nickel hydroxide electrodes that incorporate a nickel hydroxide active material are useful for a variety of battery cells. For example, they may be used as the positive electrode for nickel cadmium, nickel hydrogen, nickel zinc and nickel-metal hydride battery cells.

Nickel hydroxide electrodes may be made in different ways. One way of making a nickel hydroxide electrode is as a sintered electrode. The process for making a sintered electrode includes the preparation of a nickel slurry which is used to coat a metal grid (typically formed of steel or nickel-plated steel). After the grid is coated, the slurry is dried and sintered. The drying removes excess water while the sintering process involves heating at high temperature in a reducing gas environment (such as a nitrogen/hydrogen environment). The sintering process may also involve an additional chemical or electrochemical impregnation step. Impregnation involves immersing the grid in a solution of an appropriate nickel salt (which, in addition to the nickel salt, may also include some cobalt or other desirable additives) and then converting the nickel salt to nickel hydroxide. The total loading of nickel hydroxide onto the metal grid can be built up by repeated impregnation steps. Sintered electrodes are extremely robust and can withstand the stresses induced by the constant expansion and contraction of the active materials within the pores of the support structure. However, sintered electrodes suffer from low specific energy (they have a low loading density per unit volume) as well as the disadvantage of being very time consuming, labor intensive and expensive to make.

Nickel hydroxide electrodes may also be made as “pocket plate” electrodes. Pocket plate electrodes are produced by first making an active electrode composition (which, in addition to the nickel hydroxide active material, may also include cobalt, cobalt oxide and a binder). The active electrode composition is then placed into pre-formed pockets of conductive substrates. The edges of the pockets are crimped to prevent the active composition from falling out. The pocket plate electrodes are relatively cheaper than sintered electrodes but are limited to low current discharges due to their greater thickness. In addition, pocket plate electrodes are heavy and are not easy to make.

Nickel hydroxide electrodes may also be made as controlled micro-geometry electrodes. Micro-geometric electrodes are formed as a conductive perforated foil of nickel between thin layers of nickel hydroxide. The integrity and performance of these electrodes is questionable and their cost is relatively high.

Nickel hydroxide electrodes may also be made as pasted electrodes. In this case, the nickel hydroxide active material is made into a paste with the addition of a binder (such as a PVA binder), a thickener (such as carboyxmethyl cellulose) and water. The active composition paste is then applied to a conductive substrate. Typically, the active composition paste is applied to a conductive nickel foam. The foam provides a three-dimensional conductive support structure for the paste. Disadvantages of the foam is its relatively large thickness as well as its relatively high cost. Pasted nickel hydroxide electrodes are typically produced with high specific energy in mind. For hybrid electric vehicle applications, high specific power rather than high specific energy levels are needed. To achieve such high specific power it is preferable that the thicknesses of the electrode be reduced (possibly less than ¼^{th} of current electrode thicknessess). Fabrication of such thin nickel hydroxide electrodes has been difficult due to the inherent loss of strength of the foam support structure when the foam is calendered to small thicknesses.

There is a need for a new method of making nickel hydroxide electrodes for electrochemical battery cells. Current research has been concentrated to find alternative methods of manufacturing nickel hydroxide electrodes.

### SUMMARY OF THE INVENTION

One aspect of the present invention is a method for making an electrode of an electrochemical cell, comprising: combining an active electrode material with a polymeric binder to form an active composition; melting the polymeric binder; and extruding the active composition. In addition, it is possible that a pore structure also may be formed in the active composition.

### BRIEF DESCRIPTION OF THE DRAWINGS

FIG. 1 is a simplified diagram of a single screw extruder; and

FIG. 2 is diagram of an alkaline fuel cell.

### DETAILED DESCRIPTION OF THE INVENTION

Disclosed herein is a method for making an electrode for an electrochemical cell by using an extrusion process. The process, while particularly useful for making nickel hydroxide electrodes for electrochemical battery cells, may be used to make both positive electrodes and negative electrodes for all types of electrochemical cells. Generally, the electrochemical cell may be any type of electrochemical cell known in the art and includes battery cells, fuel cells and electrolyzer cells. The electrochemical cells include both non-aqueous as well as aqueous cells electrochemical cells. As noted above, an example of a non-aqueous electrochemical cell is a lithium-ion battery cell. Also, as noted above, aqueous electrochemical cells may be either acidic or alkaline.

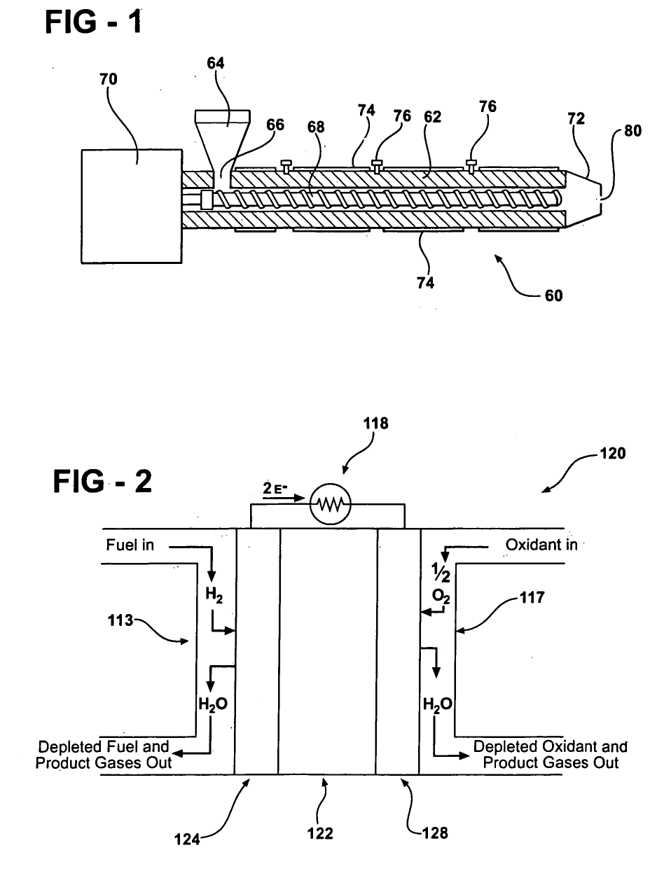

The extrusion process of the present invention is preferably carried out using an extruder. Generally, any type of extruder, such as a single screw extruder or a twin screw extruder, may be used. A simplified diagram of an example of a single screw extruder 60 is shown in FIG. 1. The extruder 60 includes a barrel 62 arranged horizontally for receiving the component materials that form the active composition for the electrode of an electrochemical cell. The active composition for an electrode of an electrochemical cell may also referred to herein as an “active electrode composition”. The active electrode composition comprises at least an active electrode material and a polymeric binder. Other component materials may be included.

The component materials for the active electrode composition are placed into the hopper 64. The hopper 64 communicates with the port 66 in the barrel 62 so that the component materials placed in the hopper 64 are delivered through the port 66 into the barrel interior. The extruder 60 further includes a screw 68 disposed in the interior of the barrel 62. A drive 70 mounted at the rear or upstream end of the barrel drives the screw 68 so that is undergoes a rotating motion relative to the barrel axis. As the screw rotates, it pushes or advances axially the component materials introduced into the interior of the barrel 62. In addition, the screw also mixes the component materials together to form an active electrode composition that is in the form of a physical mixture. While not shown in the simplified diagram of FIG. 1, the screw 68 may include specially designed mixing sections adapted to provide enhanced mixing capabilities so as to thoroughly mix the components materials together to form the active electrode composition. It is noted that it is also possible that the component materials be mixed together outside of the extruder and that the resulting mixture be introduced into the extruder via the hopper. Mixing may be accomplished by a ball mill (with or without the mixing balls), a blending mill, a sieve, or the like.

The screw 68 advances the resulting mixture of the component materials to an output die 72 disposed at the forward or downstream end of the barrel. The extruder 60 includes electric heating bands 74 that supply heat to the barrel 62. The temperature of the barrel is measured by the thermocouples 76. The heat provided by the heating bands heats the component materials as well as the resulting mixture as the component materials and the mixture move downstream toward the output die 72.

The output die 72 includes an opening 80. The rotational motion of the screw provides sufficient back pressure to the active electrode composition that is within the barrel interior to push or extrude the active electrode composition out of the opening. The opening 80 is preferably in the form of a thin slot. Hence, the active composition that is extruded out of the opening 80 preferably takes the form of a substantially flat solidified sheet of material.

The active electrode composition may thus formed by mixing together and heating the component materials so as to form a heated mixture of the component materials. As noted, the active electrode composition comprises at least an active electrode material and a polymeric binder. As discussed below, other component materials such as conductive particles (e.g. conductive fibers), pore forming agents, or conductive polymers may optionally be added.

The heating bands preferably provide sufficient heat so as to melt the polymeric binder. That is, the polymeric binder is preferably brought to the melt stage. While not wishing to be bound by theory, it is believed that melting the polymeric binder provides for an active electrode composition having a substantially uniform composition.

The polymeric binder is preferably chosen as one which is stable in an alkaline electrolyte. For example, the polymeric binder is preferably chosen so that it is stable in an aqueous solution of an alkali metal hydroxide (such as potassium hydroxide, lithium hydroxide, sodium hydroxide, or mixtures thereof).

Also, the polymeric binder is preferably chosen to be one having a melting temperature which is below the thermal stability temperature of the active electrode material being used. When the temperature of the active electrode material goes above its thermal stability temperature it is no longer useful as an active electrode material. For example, when the temperature of nickel hydroxide goes above its thermal stability temperature (a temperature above about 140° C. to about 150° C.), the nickel hydroxide dehydrates whereby the nickel hydroxide is converted to nickel oxide and is no longer useful as an active electrode material. In one embodiment of the invention (particularly when nickel hydroxide is used as the active electrode material) the polymeric binder may be one having a melting point which is preferably below about 150° C. and more preferably one having a melting point below about 140° C.

The polymeric binder may be a polyolefin. Examples of polyolefins which may be used include polypropylene (PP), high density polyethylene (HDPE), low density polyethylene (LDPE) and ethylene vinyl acetate (EVA). Preferably, the polymeric binder is a low density polyethylene (LDPE) or ethylene vinyl acetate (EVA) (or mixtures of the two). More preferably, the polymeric binder is ethylene vinyl acetate (EVA). The EVA chosen is preferably one having a melting temperature of about 110° C. and a melt index of about 2.

The polymeric binder may be a fluoropolymer. An example of a fluoropolymer is polytetrafluoroethylene (PTFE). Other fluoropolymers which may be used include fluorinated perfluoroethlene-propylene copolymer (FEP), perfluoro alkoxy alkane (PFA), ethylene-tetrafluoroethylene (ETFE), polyvinylidene fluoride (PVDF), polychlorotrifluoroethylene (CTFE), ethylene chlorotrifluoroethylene (ECTFE), polyvinyl fluoride (PVF).

As noted above, the active electrode composition (preferably in the form of a mixture) is extruded from a slot of the output die to form a continuous solidified sheet of the active electrode composition. The thickness of the extruded sheet of active composition may be controlled by changing the thickness of the slot.

The extruded sheet of active composition may be affixed onto a conductive substrate to form a continuous electrode referred to as an “electrode web”. In particular, the extruded sheet of active composition may be roll compressed onto a conductive substrate. Generally, the conductive substrate used may be any conductive substrate known in the art. Examples of conductive substrates which may be used will be discussed in more detail below. Preferably, the conductive substrate is a perforated metal sheet or an expanded metal sheet so that the electrode web may be made relatively thin. In addition, the perforated metal sheet or the expanded metal sheet may be used to replace the relatively more expensive conductive foam, thereby reducing the cost of electrode production. The continuous electrode web is cut to form individual electrode plates with desired geometrical dimensions. Electrode tabs may then be attached (preferably by welding) to the electrode plates.

The active electrode material used in the present invention may be any active electrode material known in the art and includes active electrode materials for battery cells as well as active electrode material for fuel cells. The active electrode material may be an active positive electrode material or an active negative electrode material. The active positive electrode material may be an active material for the positive electrode of a battery cell or it may be an active material for the positive electrode of a fuel cell (where the positive electrode of a fuel cell is the air electrode and is also referred to as the “cathode” of the fuel cell). The active negative electrode material may be an active material for the negative electrode of a battery cell or it may be the active material for the negative electrode of a fuel cell (where the negative electrode of a fuel cell is the hydrogen electrode and is also referred to as the fuel cell “anode”). Any active positive electrode material and any active negative electrode material (for either a battery cell or a fuel cell) is within the scope of this invention.

Examples of active electrode materials for a positive electrode of a battery cell include, but are not limited to, lead oxide/lead dioxide, lithium cobalt dioxide, lithium nickel dioxide, lithium manganese oxide compounds, lithium vanadium oxide compounds, lithium iron oxide, lithium compounds (as well as complex oxides of these compounds), other materials known to posses lithium intercalation, transition metal oxides, manganese dioxide, zinc oxide, nickel oxide, nickel hydroxide, manganese hydroxide, copper oxide, molybdenum oxide and carbon fluoride. Combinations of these materials may also be used. A preferred active positive electrode material for a battery cell is a nickel hydroxide material. It is within the scope of this invention that any nickel hydroxide material may be used. Examples of nickel hydroxide materials are provided above. The active positive electrode material may even include externally added conductivity enhancers as well as internally embedded conductive materials (such as nickel fibers) as disclosed in U.S. Pat. No. 6,177,213, the disclosure of which is hereby incorporated by reference herein.

The active positive electrode material for the positive electrode of a fuel cell (also referred to as the oxygen electrode or “cathode”) may include catalytic materials such as platinum, silver, manganese, manganese oxides (such as manganese dioxide), and cobalt. Typically, these catalytic materials are added to a mainly carbon/Teflon based high surface area particulate.

Examples of active negative electrode materials for the negative electrode of a battery cell include, but not limited to, metallic lithium and like alkali metals, alkali metal absorbing carbon materials, zinc, zinc oxide, cadmium, cadmium oxide, cadmium hydroxide, iron, iron oxide, and hydrogen storage alloys. A preferred active negative electrode material for the negative electrode of a battery cell is a hydrogen storage alloy. Generally, any hydrogen storage alloy may be used. Hydrogen storage alloys include, without limitation, AB, AB₂ and AB₅ type alloys. For example, hydrogen storage alloys may be selected from rare-earth/Misch metal alloys, zirconium alloys or titanium alloys. In addition mixtures of alloys may be used. An example of a particular hydrogen storage material is a hydrogen storage alloy having the composition (Mm)ₐNibCocMndAle where Mm is a Misch Metal comprising 60 to 67 atomic percent La, 25 to 30 weight percent Ce, 0 to 5 weight percent Pr, 0 to 10 weight percent Nd; b is 45 to 55 weight percent; c is 8 to 12 weight percent; d is 0 to 5.0 weight percent; e is 0 to 2.0 weight percent; and a+b+c+d+e=100 weight percent. Other examples of hydrogen storage alloys are described above.

The active electrode material for the negative electrode (also referred to as the hydrogen electrode or anode) of a fuel cell may include catalytic materials such as hydrogen storage alloys and noble metals (e.g. platinum, palladium, gold, etc.). Typically, these catalytic materials are added to a mainly carbon/Teflon based high surface area particulate.

When the electrode is formed using an extrusion process, additional component materials may be added to the active electrode composition. The additional materials may be introduced into the active electrode composition by being placed in the extruder via the hopper. For example, the active electrode composition may also include an additional conductive material (e.g., a conductive additive) which aids in the electrical conductivity within the electrode. The conductive material may include carbon. The carbon may be in the form of a graphite or graphite containing composite. The conductive material may be a metallic material such as a pure metal or a metallic alloy. Metallic materials include, but not limited to, metallic, a nickel alloy, metallic copper, copper alloy, metallic silver, silver alloy, metallic copper plated with metallic nickel, metallic nickel plated with metallic copper. The conductive material may include at least one periodic table element selected from the group consisting of carbon, copper, nickel, and, silver. That is, the conductive material may include at least one periodic table element selected from the group consisting of C, Cu, Ni and Ag.

The conductive material may be in the form of particles. The particles may have any shape and may be in the form of fibers. In addition, any other conductive material which is compatible with the environment of the electrode may also be used. (The electrode environment includes factors such as pH of the surrounding electrolyte as well as potential of the electrode itself). In addition, any of the well known electrode performance enhancing materials such as cobalt or cobalt oxide may be added in appropriate amounts to the active electrode composition.

Other components such as pore formers may also be added to active electrode composition so as to increase the porosity (and, hence, the surface area) of the active electrode composition. Generally, any type of pore former known in the art may be added to the active composition. In one example, pores may be formed by adding particles to the active composition that is within the extruder and then removing these particles after the active composition is extruded out of the output die of the extruder. (The particles may be removed from the active composition either before or after the active composition is affixed to the conductive substrate). Removing the particles leaves behind pores in the extruded sheet of active composition. Such pore forming particles may be added to the active composition by being placed into the hopper of the extruder. Any water-soluble inorganic salt which is thermally stable at the processing temperature within the extruder (which is preferably below about 150° C. and more preferably below about 140° C.) is suitable for such purposes. An example of a pore forming particle is sodium chloride (e.g. salt). The sodium chloride is typically stable at the temperature within the interior of the barrel of the extruder (which, as described above, is preferably at or above the melting point of the polymeric binder but below the stability temperature of the active electrode material). After the active composition is extruded through the opening of the output die, the sodium chloride may be removed from the extruded sheet of active composition by placing the extruded sheet in water. The water dissolves out the sodium chloride, leaving behind pores. The overall electrode porosity as well average pore size can be precisely controlled by controlling the amount of pore former used. It is noted that any material which is stable at the temperature within the interior of the barrel of the extruder and which can be dissolved out of the extruded sheet of active composition may be used. The material used is preferably one which can be dissolved out of the active electrode sheet by an aqueous solvent (such as water), however, it is possible that materials which can be dissolved out by a non-aqueous solvent may also be used. For example, mineral oil may be added to the active composition as a pore former. The mineral oil may be dissolved out of the extruded active electrode sheet by an organic solvent.

Pores may also be formed by adding materials called “foaming agents” to the active composition within the extruder. The foaming agent may be any chemical compound that can decompose at the extrusion temperature to form a gas. Examples of foaming agents include sodium carbonate, sodium bicarbonate, ammonium carbonate and ammonium bicarbonate. One or more of these materials may be added to the active composition by being placed into the input hopper of the extruder. Typically, the foaming agent is added to the active electrode composition but then decomposes within the extruder at the temperature of the extrusion process (that is at the temperature of the active composition within the interior of the extruder). As the foaming agent materials decompose, gases are released and pores are formed within the active electrode composition. As an example, if either ammonium carbonate or ammonium bicarbonate is added to the hopper and mixed in with the active composition within the extruder, the extruder heats the ammonium carbonate or ammonium bicarbonate which thereby decomposes to form ammonia gas and carbon dioxide gas. Likewise, if sodium carbonate or sodium bicarbonate is added to the hopper and mixed in with the active composition, the extruder heats the sodium carbonate or sodium bicarbonate to form carbon dioxide gas. The gases form pores in the active electrode composition. The overall electrode porosity as well average pore size can be easily and precisely controlled by controlling the amount of foaming agent used.

Pores may also be formed in the active electrode composition by the direct injection of a gas into the active composition within the extruder. The direct injection of gas causes the formation of pores within the active electrode composition. Preferably, the direct injection of gas takes place when the polymeric binder that is already melted within the extruder just prior to the extrusion of the active composition from the opening of the output die.

The introduction of pores into the active composition increases the porosity and, hence, the surface area of the active composition. Increased porosity thereby increases the exposure and accessibility of the active electrode material to the electrolyte of the electrochemical cell, thereby increasing the amount of the active material which is utilized. The increased exposure also increases the catalytic properties of the active material. It is noted that the degree of porosity can be controlled by controlling the amount of the pore forming agents introduced into the extruder.

A conductive polymer may also be added as a component material of the active electrode composition. This may be done by placing the conductive polymer into the hopper of the extruder. The conductive polymers used in the active composition are intrinsically electrically conductive materials. Generally, any conductive polymer may be used in the active composition. Examples of conductive polymers include conductive polymer compositions based on polyaniline such as the electrically conductive compositions disclosed in U.S. Pat. No. 5,783,111, the disclosure of which is hereby incorporated by reference herein. Polyaniline is a family of polymers. Polyanilines and their derivatives can be prepared by the chemical or electrochemical oxidative polymerization of aniline (C₆H₅NH₂). Polyanilines have excellent chemical stability and relatively high levels of electrical conductivity in their derivative salts. The polyaniline polymers can be modified through variations of either the number of protons, the number of electrons, or both. The polyaniline polymer can occur in several general forms including the so-called reduced form (leucoemeraldine base) possessing the general formula

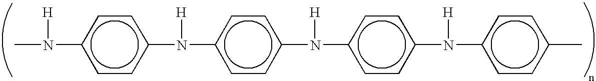

the partially oxidized so-called emeraldine base form, of the general formula

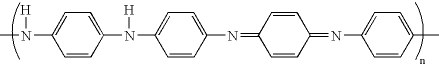

and the fully oxidized so-called pernigraniline form, of the general formula

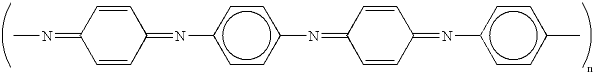

In practice polyaniline generally exists as a mixture of the several forms with a general formula (I) of

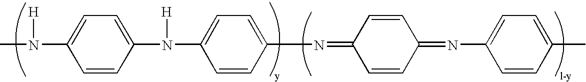

When 0≦y≦1, the polyaniline polymers are referred to as poly(paraphenyleneamineimines) in which the oxidation state of the polymer continuously increases with decreasing value of y. The fully reduced poly(paraphenylenamine) is referred to as leucoemeraidine, having the repeating units indicated above corresponds to a value of y=0. The fully oxidizedpoly(paraphenyleneimine) is referred to as pernigraniline, of repeat unit shown above corresponds to a value y=0. The partly oxidized poly(paraphenyleneimine) with y in the range of greater than or equal to 0.35 and less than or equal to 0.65 is termed emeraldine, though the name emeraldine is often focused on y equal to or approximately 0.5 composition. Thus, the terms “leucoemeraldine”, “emeraldine” and “pernigraniline” refer to different oxidation states of polyaniline. Each oxidation state can exist in the form of its base or in its protonated form (salt) by treatment of the base with an acid.

The use of the terms “protonated” and “partially protonated” herein includes, but is not limited to, the addition of hydrogen ions to the polymer by, for example, a protonic acid, such as an inorganic or organic acid. The use of the terms “protonated” and “partially protonated” herein also includes pseudoprotonation, wherein there is introduced into the polymer a cation such as, but not limited to, a metal ion, M+. For example, “50%” protonation of emeraldine leads formally to a composition of the formula:

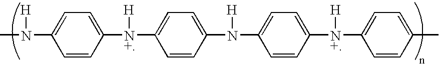

Formally, the degree of protonation may vary from a ratio of [H+]/[−N=]=0 to a ratio of [H+]/[—N=]=1. Protonation or partial protonation at the amine (—NH—) sites may also occur.

The electrical and optical properties of the polyaniline polymers vary with the different oxidation states and the different forms. For example, the leucoemeraldine base forms of the polymer are electrically insulating while the emeraldine salt (protonated) form of the polymer is conductive. Protonation of the emeraldine base by aqueous HCl (1M HCl) to produce the corresponding salt brings about an increase in electrical conductivity of approximately 10¹⁰. The emeraldine salt form can also be achieved by electrochemical oxidation of the leucoemeraldine base polymer or electrochemical reduction of the pernigraniline base polymer in the presence of the electrolyte of the appropriate pH level.

Some of the typical organic acids used in doping emeraldine base to form conducting emeraldine salt are methane sulfonic acid (MSA) CH3—SO3H, toluene sulfonic acid (TSA), dodecyl bezene sulphonic acid (DBSA), and camphor sulfonic acid (CSA).

Other examples of conductive polymers include conductive polymer compositions based on polypyrrole. Yet other conductive polymer compositions are conductive polymer compositions based on polyparaphenylene, polyacetylene, polythiophene, polyethylene dioxythiophene, polyparaphenylenevinylene.

The conductive polymer may preferably be between about 0.1 weight percent and about 25 weight percent of the active composition. In one embodiment of the invention, the conductive polymer may preferably be between about 10 weight percent and about 20 weight percent of the active composition.

The active electrode composition of the present invention may further include a Raney catalyst, a Raney alloy or some mixture thereof. The Raney catalyst and/or Raney alloy may be added to the active electrode composition by being placed into the extruder via the hopper.

A Raney process refers to a process for making a porous, active metal catalyst by first forming at least a binary alloy of metals, where at least one of the metals can be extracted, and then extracting that metal whereby a porous residue is obtained of the insoluble metal which has activity as a catalyst. See for example, “Catalysts from Alloys-Nickel Catalysts” by M. Raney, Industrial and Engineering Chemistry, vol. 32, pg. 1199, September 1940. See also U.S. Pat. Nos. 1,628,190, 1,915,473, 2,139,602, 2,461,396, and 2,977,327. The disclosures of U.S. Pat. Nos. 1,628,190, 1,915,473, 2,139,602, 2,461,396, and 2,977,327 are all incorporated by reference herein. A Raney process metal refers to any of a certain group of the insoluble metals well known in the Raney process art which remain as the porous residue. Examples of insoluble Raney process metals include, not limited to, nickel, cobalt, silver, copper and iron. Insoluble alloys of nickel, cobalt, silver, copper and iron may also be used.

A Raney alloy comprises an insoluble Raney process metal (or alloy) and a soluble metal (or alloy) such as aluminum, zinc, or manganese, etc. (Silicon may also be used as an extractable material). An example of a Raney alloy is a Raney nickel-aluminum alloy comprising the elements nickel and aluminum. Preferably, the Raney nickel-aluminum alloy comprises from about 25 to about 60 weight percent nickel and the remainder being essentially aluminum. More preferably, the Raney nickel-aluminum alloy comprises about 50 weight percent nickel and about 50 weight percent aluminum.

A Raney catalyst is a catalyst made by a Raney process which includes the step of leaching out the soluble metal from the Raney alloy. The leaching step may be carried out by subjecting the Raney alloy to an aqueous solution of an alkali metal hydroxide such as sodium hydroxide, potassium hydroxide, lithium hydroxide, or mixtures thereof. After the leaching step, the remaining insoluble component of the Raney alloy forms the Raney catalyst.

An example of a Raney catalyst is Raney nickel. Raney nickel may be formed by subjecting the Raney nickel-aluminum alloy discussed above to the Raney process whereby most of the soluble aluminum is leached out of the alloy. The remaining Raney nickel may comprise over 95 weight percent of nickel. For example, a Raney alloy in the form of a 50:50 alloy of aluminum and nickel (preferably in the form of a powder) may be placed in contact with an alkaline solution. The aluminum dissolves in the solution thereby leaving behind a finely divided Raney nickel particulate. (The particulate may then be filtered off and added to the active electrode composition of the present invention). Other examples of Raney catalysts are Raney cobalt, Raney silver, Raney copper, and Raney iron.

As noted above, a Raney alloy may be added to the active electrode composition instead of (or in addition to) a Raney catalyst. It may thus be possible to form the Raney catalyst “in situ” by adding a Raney alloy to the active composition of the electrode. For example, a Raney alloy (such as a nickel-aluminum alloy) may be mixed in with a hydrogen storage alloy to form an active composition for a negative electrode of an alkaline nickel-metal hydride battery cell. The alkaline electrolyte of the battery cell may then leach out the aluminum so that a Raney nickel catalyst is thus formed. As noted above, the Raney alloy may be added to the electrodes in any way. Further discussion of the Raney alloys and Raney catalysts is provided in U.S. Pat. No. 6,218,047, the disclosure of which is hereby incorporated by reference herein.

In addition, additives useful for improving high-temperature performance of the electrochemical cell may also be added during the extrusion process. Specific examples of such additives include calcium cobalt oxide, calcium titanium oxide, calcium molybdenum oxide, and lithium cobalt oxide. These additives are particularly useful when making a nickel hydroxide electrode. While not wishing to be bound by theory, it is believed that these additives may serve to increase the electrochemical potential of the oxygen evolution reaction at high temperatures. As a result, the charging reaction of nickel hydroxide to nickel oxyhydroxide sufficiently proceeds to improve the utilization of the nickel positive electrode in the high temperature atmosphere. Further discussion of these additives may be found in U.S. Pat. No. 6,017,655, the disclosure of which is hereby incorporated by reference herein.

Other additives which may improve the high-temperature performance of a nickel hydroxide electrode include minerals such as rare earth minerals (e.g., bastnasite, monazite, loparaite, xenotime, apatite, eudialiyte, and brannerite) and rare earth concentrates (e.g., bastnasite concentrate, monazite concentrate, loparaite concentrate, xenotime concentrate, apatite concentrate, eudialiyte concentrate, and brannerite concentrate). Further discussion of such mineral additives is discussed in U.S. Pat. No. 6,150,054, disclosure of which is incorporated by reference.

Yet other additives to increase high-temperature performance include misch-metal alloys, and, in particular, misch-metal alloys that include transition metals (such as nickel).

Additional binder materials may be introduced into the extruder and added to the active composition which can further increase the particle-to-particle bonding of the active electrode material. The binder materials may, for example, be any material which binds the active material together so as to prevent degradation of the electrode during its lifetime. Binder materials should preferably be resistant to the conditions present within the electrochemical cells. Examples of additional binder materials, which may be added to the active composition, include, but are not limited to, polymeric binders such as polyvinyl alcohol (PVA), carboxymethyl cellulose (CMC) and hydroxypropylymethyl cellulose (HPMC). Other examples of additional binder materials, which may be added to the active composition, include elastomeric polymers such as styrene-butadiene. In addition, depending upon the application, additional hydrophobic materials may be added to the active composition (hence, the additional binder material may be hydrophobic).

As noted above, after the active electrode composition is extruded from the opening of the output die, the resulting extruded sheet of active composition may be affixed to a conductive substrate to form a continuous electrode web (which is subsequently cut into individual electrodes). Preferably, the extruded active composition is compressed onto the conductive substrate. The conductive substrate may be any electrically conductive support structure known in the art. Examples include mesh, grid, foam, expanded metal and perforated metal. Preferably, the conductive substrate is a mesh, grid, expanded metal or a perforated metal so that the resulting electrode is relatively thin.

The conductive substrate may be formed of any electrically conductive material and is preferably formed of a metallic material such as a pure metal or a metal alloy. Examples of materials that may be used include metallic nickel, nickel alloy, metallic copper, copper alloy, nickel-plated metals such as metallic nickel plated with metallic copper and metallic copper plated with metallic nickel. The actual material used for the substrate depends upon many factors including whether the substrate is being used for the positive or negative electrode, the type of electrochemical cell (for example battery or fuel cell), the potential of the electrode, and the pH of the electrolyte of the electrochemical cell.

It is noted that an electrode may be formed without a conductive substrate. For example, conductive fibers may be mixed in with the active composition to form the necessary conductive collecting pathways. Hence, it is possible that the extruded sheet of active composition may be used to form the electrodes without the use of any additional conductive substrate.

The process of the present invention may be used to form electrodes for all types of electrochemical cells, including positive and negative electrodes for battery cells, positive and negative electrodes for fuel cells as well as electrodes for electrolyzer cells.

An example of an electrode of the present invention is a nickel hydroxide electrode (also referred to as a nickel electrode). In this case, the active electrode composition comprises a nickel hydroxide material and a polymeric binder. Any nickel hydroxide material may be used. Examples of nickel hydroxide materials are provided above. The nickel hydroxide electrode may be used as the positive electrode of a battery cell. For example, the nickel hydroxide electrode may be used as a positive electrode of a nickel-metal hydride battery cell, a nickel-cadmium battery cell, a nickel zinc battery cell, a nickel iron battery cell or a nickel hydrogen battery cell.

Another example of an electrode of the present invention is a hydrogen storage alloy electrode. In this case the active composition includes a hydrogen storage alloy and a polymeric binder. Any hydrogen storage alloy may be used. Examples of hydrogen storage alloys are discussed above. The hydrogen storage alloy electrode may be used as the negative electrode for a battery cell such as a nickel-metal hydride battery cell. Also, the hydrogen storage alloy electrode may be used as the negative electrode of a fuel cell.

Hence, the process of the present invention may be used to make an electrode for an electrochemical cell where the electrochemical cell may be a battery cell, a fuel cell or an electrolyzer. Preferably, the electrolyte of the electrochemical cell is an alkaline electrolyte. The alkaline electrolyte is preferably an aqueous solution of an alkali metal hydroxide. Examples of alkali metal hydroxides include potassium hydroxide, sodium hydroxide, lithium hydroxide, and mixtures thereof. Preferably, the alkali metal hydroxide is potassium hydroxide.

One embodiment of an electrochemical battery cell that may be formed using the method of the present invention is a nickel-metal hydride battery cell. The nickel-metal hydride battery cell includes at least one hydrogen storage alloy negative electrode, at least one nickel hydroxide positive electrode and an alkaline electrolyte.

As noted, the electrochemical cell may also be a fuel cell. Fuel cells operate by continuously supplying the reagents (fuel) to the both positive and negative electrodes, where they react by utilizing the corresponding electrochemical reactions. Unlike a battery in which chemical energy is stored within the cell, fuel cells generally are supplied with reactants from outside the cell. The fuel cell may be any type of fuel cell. Examples of fuel cells include alkaline fuel cells and PEM fuel cells.

The fuel cell includes at least one negative electrode and at least one positive electrode. The negative electrode serves as the hydrogen electrode or anode of the fuel cell while the positive electrode serves as the air electrode or cathode of the fuel cell. A simplified example of an alkaline fuel cell is shown in FIG. 2. As shown in FIG. 2, an alkaline fuel cell 120 comprises an anode 124, a cathode 126 and an alkaline electrolyte 122 held within a porous non-conducting matrix between the anode 124 and the cathode 126. As noted above, the alkaline material is preferably an aqueous solution of an alkali metal hydroxide. The alkali metal hydroxide may include one or more of potassium hydroxide, lithium hydroxide or sodium hydroxide. Potassium hydroxide is typically used as the electrolyte in an alkaline fuel cell.

A hydrogen gas is fed to the anode 124 and an oxygen gas is fed to the cathode 126. In the embodiment shown, the hydrogen gas is fed to the anode 124 via the hydrogen compartment 113, and the oxygen gas is fed to the cathode 126 via the oxygen/air compartment 117. The reactant gases pass through the electrodes to react with the electrolyte 122 in the presence of the catalyst to produce water, heat and electricity. At the anode 124 the hydrogen is electrochemically oxidized to form water and release electrons according to the reaction:

H₂(g)+2OH [symbol] 2H₂O+2e⁻ (45)

The electrons so generated are conducted from the anode 124 through an external circuit to the cathode 126. At the cathode 126, the oxygen, water and electrons react to reduce the oxygen and form hydroxyl ions (OH⁻) according to the reaction:

½O₂(g)+H₂O+2e⁻ [symbol] 20H⁻ (6)

A flow of hydroxyl (OH⁻) ions through the electrolyte 22 completes the electrical circuit. The flow of electrons is utilized to provide electrical energy for a load 118 externally connected to the anode (the negative electrode) and the cathode (the positive electrode).

The anode catalyst is the active electrode material of the negative electrode (the anode) of the fuel cell. Likewise, the cathode catalyst is the active electrode material of the positive electrode (the cathode) of the fuel cell. For an alkaline fuel cell, the anode catalyst catalyzes and accelerates the formation of H⁺ ions and electrons (e⁻) from H₂. This occurs via formation of atomic hydrogen from molecular hydrogen. The overall reaction (were M is the catalyst) is equation (7) below:

M+H₂→2 MH+2H⁺+2e⁻ (7)

Thus the anode catalyst catalyzes the formation of water at the electrolyte interface and also efficiently dissociates molecular hydrogen into ionic hydrogen. Examples of possible anode catalysts include materials that include one or more of the noble metals such as platinum, palladium and gold. Other anode catalysts include hydrogen storage alloys. Hence, the anode catalyst (that is, the active material for the negative electrode of the fuel cell) may be a hydrogen storage alloy. Generally, any hydrogen storage alloy may be used as the anode catalyst. An example of an alkaline fuel cell using a hydrogen storage alloy as an anode catalyst is provided in U.S. Pat. No. 6,447,942, the entire disclosure of which is incorporated by reference herein.

As noted, the positive electrode of the fuel cell is the air electrode or cathode of the fuel cell. The fuel cell cathode includes an active cathode material which is preferably catalytic to the dissociation of molecular oxygen into atomic oxygen and catalytic to the formation of hydroxide ions (OH⁻) from water and oxygen ions. Examples of such catalytic material include noble metals such as platinum as well as non-noble metals such a silver. Typically, the catalytic material (such as the platinum or the silver) is distributed onto a support (which preferably has a relatively high surface area). An example of a support is a particulate (such as a carbon particulate) having a relatively high porosity. The anode and/or cathode of the fuel cell may be formed by the extrusion process of the present invention.

Electrodes formed by the extrusion process of the present invention have several advantages over electrodes formed by more conventional methods such as sintering and pasting. For example, when the electrodes (such as nickel hydroxide electrodes) are formed using the extrusion process, it is not necessary to use the relatively expensive nickel foam as the conductive substrate. A less expensive substrate such as screen, perforated metal or expanded metal may be substituted for the foam.

Also, the extrusion process of the present invention allows for the continuous production of electrodes having a controllable thickness. As noted above, a continuous sheet of active composition is extruded from the opening of the output die of the extruded. The extruded active composition may be affixed to a conductive substrate to form a continuous electrode web which is later cut into individual electrodes.

In addition, the extrusion process of the present invention may reduce the amount of electrode material wasted. For example, when using the extrusion process to make electrodes, the active composition extruded from the opening of the die but not initially used to make an electrode may be saved and then fed back into the hopper of the extruder at a later time. The raw materials fed into the hopper can thus be reprocessed rather than be thrown away.

Hence, the extrusion process of the present invention, provides for a process of making electrodes which may be more efficient and less costly than other more conventional methods.

### EXAMPLES

The extruder used for Examples 1-5 below was a single screw extruder. The following materials were used in Examples 1-6 below.

1) Base Material (Includes Nickel Hydroxide Active Material):

89% nickel hydroxide, 5% cobalt, and 6% cobalt oxide

2) polymeric binder:

An ethylene-vinyl acetate copolymer (EVA), film extrusion grade with 9% vinyl acetate content and a melt index of about 3.2.

3) mineral oil:

A white mineral oil having a specific gravity of 0.864 @25° C. and a viscosity of 95 cSt @40° C.

### Example 1

An active composition was formed by premixing 65.0% base material, 29.0% polymeric binder and 6.0% mineral oil. The premixed active composition was placed into the single screw extruder at four different operating conditions to produce four different batches of extruded active compositions. The corresponding operating conditions for Extrusions 1A-1D are as follows:

| Run # | Processing Temperature | Screw Speed |
|---|---|---|
| 1A | 130° C. | 100 rpm |
| 1B | 110° C. | 50 rpm |
| 1C | 100° C. | 100 rpm |
| 1D | 110° C. | 40 rpm |

All runs produced cohesive, flexible extruded sheet of active composition having a thickness of about 0.010 inch.

### Example 2

Using the extruder processing conditions shown in Example 1, several extruded sheet of active composition where produced using the following range of material compositions:

base material: 60-90 wt %

polymeric binder: 10-40 wt %

mineral oil: 0-10 wt %

### Example 3

An active composition was formed which included a conductive additive. The Table below gives the composition ranges of component materials used as well as the processing temperature. All processing was performed using a screw speed of about 50 rpm. All runs gave cohesive, flexible extruded sheets of active composition with a thickness of about 0.010 inch.

TABLE

| | Composition (wt %) | | | | | |
|---|---|---|---|---|---|---|
| | | | | Conductive | Conductive | |
| | Active | Polymer | | Additive | Additive | Process |
| Run # | Material | EVA | Mineral Oil | (Amount) | (Type) | Temp. (° C.) |
| 3A | 65 | 29 | 6 | — | | 110 |
| 3B | 62 | 29 | 6 | 3 | Carbon Black | 130 |
| 3C | 66 | 18 | 12 | 4 | Carbon Black | 130 |
| 3D | 72 | 15 | 9 | 4 | Carbon Black | 130 |
| 3E | 66 | 16 | 6 | 12 | Ni Powder | 110 |
| 3F | 68 | 9 | 6 | 17 | Polyaniline | 110 |
| 3G | 67 | 12 | 4 | 17 | Polyaniline | 110 |
| 3I | 67 | 12 | 4 | 17 | Polyaniline | 130 |
| 3J | 66 | 15 | 4 | 15 | Polyaniline | 130 |
| 3K | 64 | 24 | 4 | 8 | Polyaniline | 110 |

### Example 4

2 to 6 wt % of sodium bicarbonate was added to the active composition of Example 1 above. Extruded sheets of active composition formed using the sodium bicarbonate showed an increased number of pore formation with increasing amount of sodium bicarbonate addition.

### Example 5

1 to 2.5 wt % of ammonium bicarbonate to the active composition of Example 1. Extruded sheets of active composition showed increasing number of pore formation with increasing amount of ammounium bicarbonate addition.

### Example 6

The active composition of Example 1 was added to the input hopper of a twin-screw extruder to form an extruded sheet of active composition.

While the invention has been described in connection with preferred embodiments and procedures, it is to be understood that it is not intended to limit the invention to the preferred embodiments and procedures. On the contrary, it is intended to cover all alternatives, modifications and equivalence, which may be included within the spirit and scope of the invention as defined by the claims appended hereinafter.

We claim:

1. A method for making an electrode of an electrochemical cell, comprising:
combining an active electrode material with a polymeric binder to form an active composition;
melting said polymeric binder; and
extruding said active composition.

2. The method of claim 1, wherein said combining step comprises mixing said active electrode material and said polymeric binder.

3. The method of claim 1, wherein said melting step is performed during said combining step.

4. The method of claim 1, wherein said melting step is performed after said combining step.

5. The method of claim 1, further comprising the step of affixing said extruded active composition onto a conductive substrate.

6. The method of claim 1, wherein the melting temperature of said polymeric binder is less than the stability temperature of said active material.

7. The method of claim 1, wherein said method further comprises the step of forming pores in said active composition.

8. The method of claim 7, wherein said pore forming step comprises the step of introducing a material into said active composition before said active composition is extruded and removing said material after the active composition is extruded.

9. The method of claim 8, wherein said material is sodium chloride.

10. The method of claim 7, wherein said pore forming step comprises the step of introducing a material into said active composition and decomposing said material within said extruder to form a gas.

11. The method of claim 7, wherein said pore forming step comprises the step of introducing a gas into said active composition before said active composition is extruded.

12. The method of claim 1, wherein said combining step comprises combining said active electrode material, said polymeric binder and a conductive polymer.

13. The method of claim 1, wherein said combining step comprises combining said active electrode material, said polymeric binder and a conductive additive.

14. The method of claim 1, wherein said active electrode material is an active positive electrode material.

15. The method of claim 1, wherein said active positive electrode material is a nickel hydroxide material.

16. The method of claim 1, wherein said active electrode material is an active negative electrode material.

17. The method of claim 16, wherein said active negative electrode material includes a material selected from the group consisting of hydrogen storage alloy, cadmium, zinc, or iron.

18. The method of claim 16, wherein said active negative electrode material is a hydrogen storage alloy.

19. The method of claim 17, wherein said hydrogen storage alloy is selected from the group consisting of rare-earth/Misch metal alloys, zirconium alloys, titanium alloys, and mixtures or alloys thereof.

20. The method of claim 12, wherein said conductive polymer includes a material selected from the group consisting of polyaniline based polymers, polypyrrole based polymers, polyparaphenylene based polymers, polyacetylene based polymers, polythiophene based polymers, dioxythiophene based polymers, polyparaphenylenevinylene based polymers, and mixtures thereof.

21. The method of claim 12, wherein the weight percentage of said conductive polymer is between 0.1 weight percent and 25 weight percent of said active composition.

22. The method of claim 5, wherein said conductive substrate is selected from the group consisting of grid, mesh, perforated metal, expanded metal, and foam.

23. The method of claim 1, wherein said electrochemical cell is a battery cell.

24. The method of claim 1, wherein said electrochemical cell is a fuel cell.

25. The method of claim 1, wherein said electrochemical cell is an electrolyzer.
